(19) United States
(12) Patent Application Publication
(10) Pub. No.: US 2025/0285455 A1
(43) Pub. Date: Sep. 11, 2025

(54) EVALUATION APPARATUS, EVALUATION METHOD, AND NON-TRANSITORY COMPUTER READABLE MEDIUM

(71) Applicant: Yokogawa Electric Corporation, Tokyo (JP)

(72) Inventors: Takeru KONO, Tokyo (JP); Akio NAKABAYASHI, Tokyo (JP); Tomoya ITO, Tokyo (JP)

(21) Appl. No.: 18/939,549

(22) Filed: Nov. 7, 2024

(30) Foreign Application Priority Data
Mar. 6, 2024 (JP) 2024-033638

(51) Int. Cl. G06V 20/69; G06V 10/77

(52) U.S. Cl. CPC G06V 20/695; G06V 10/7715

(57) ABSTRACT

Provided is an evaluation apparatus comprising a prediction unit that predicts, based on a feature quantity of a prey, a feature quantity of a predator that preys upon the prey, wherein the evaluation apparatus estimates an evaluation value of the prey based on a result obtained by inputting the feature quantity of the prey to the prediction unit. The prediction unit may have a prediction model having learned, by using learning data including a set of the feature quantity of the prey and the feature quantity of the predator that preyed upon the prey, the feature quantity of the predator that is available as an evaluation value of the prey. The evaluation apparatus may comprise an estimation unit that estimates an evaluation value of the prey by using prediction of the feature quantity of the predator by the prediction unit.

The contents of the following patent application(s) are incorporated herein by reference: NO. 2024-033638 filed in JP on Mar. 6, 2024

### BACKGROUND

### 1. Technical Field

The present invention relates to an evaluation apparatus, an evaluation method, and a non-transitory computer readable medium.

### 2. Related Art

Patent document 1 describes that “the present invention relates to a method for supervised classification of cells contained in images . . . taken with microscopes.” (paragraph 0001) and that “with reference to FIG. 2, this learning step allows the accuracy of the classification to be improved by calculating prototypes for a supervised classifier resulting from cells annotated by an expert by minimizing a misclassification function, i.e. bad classification” (paragraph 0080).

Patent document 2 describes that “with an imaged image of one well W and the inside thereof as a processing target image, an image object having the form of a cell is detected from the inside of the well W in the processing target image” (paragraph 0034), that “this classifier has the function of classifying the image objects into one of a plurality of classification categories including a “living cell” category and a “dead cell” category on the basis of the feature vectors” (paragraph 0035), and that “as the fluorescent specimens, the same type of cells as the cells which are targets for determination of life or death thereof, to which labels representing different fluorescence generation modes in response to the excitation light in accordance with whether the cells are living or dead are given, are used” (paragraph 0038).

Patent document 3 describes that “in a first step 102, an image analysis system 200 . . . receives a plurality of digital tissue images 212. For example, each tissue image can depict a whole-slide tissue sample taken from a patient, e.g. a cancer patient” (paragraph 0189), that “next in step 104, the image analysis system splits each received image into a set of overlapping or non-overlapping image tiles 216” (paragraph 0190), that “next in step 106, the image analysis system computes, for each of the tiles, a feature vector 220” (paragraph 0192), and that “the trained, instantiated MIL-program then processes the tiles of the received digital tissue images at test time for classifying the received tissue images” (paragraph 0193).

### PRIOR ART DOCUMENTS

### Patent Documents

Patent Document 1: Japanese translation publication of a PCT route patent application No. 2015-508501

Patent Document 2: Japanese Patent No. 6660712

Patent Document 3: Japanese translation publication of a PCT route patent application No. 2023-501126

### BRIEF DESCRIPTION OF THE DRAWINGS

FIG. 1 illustrates a configuration of an evaluation system 10 according to the present embodiment.

FIG. 2 illustrates a learning processing flow of the evaluation system 10 according to the present embodiment.

FIG. 3 illustrates an evaluation processing flow of the evaluation system 10 according to the present embodiment.

FIG. 4 is a schematic view of a learning processing of the evaluation system 10 according to the present embodiment.

FIG. 5 is a schematic view of evaluation processing of the evaluation system 10 according to the present embodiment.

FIG. 6 illustrates a configuration of an evaluation system 60 according to a modified example of the present embodiment.

FIG. 7 illustrates an example of a computer 2200 in which a plurality of aspects of the present invention may be entirely or partially embodied.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

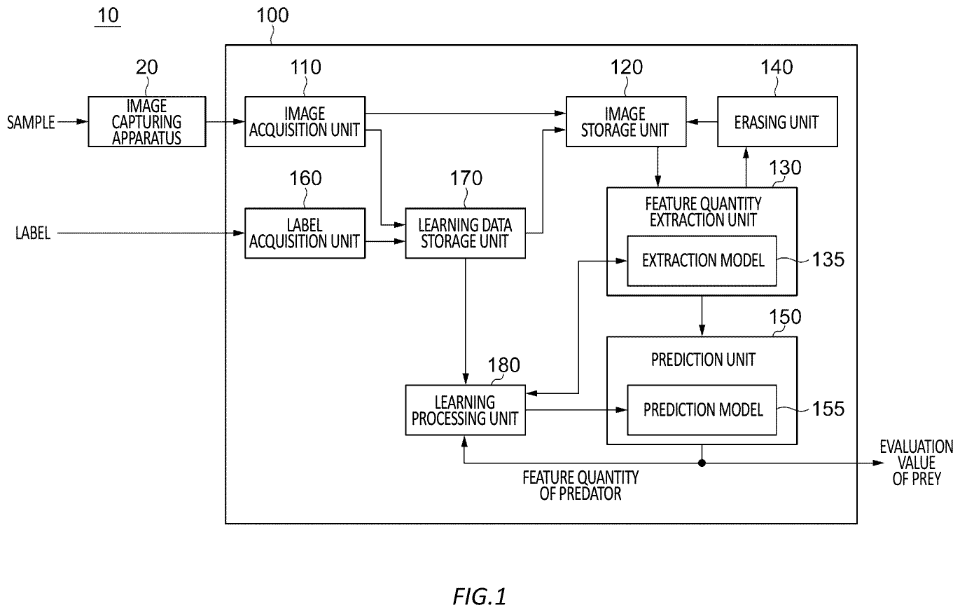

FIG. 1 illustrates a configuration of an evaluation system 10 according to the present embodiment. The evaluation system 10 comprises an image capturing apparatus 20 and an evaluation apparatus 100. The image capturing apparatus 20 captures a sample including a prey, and supplies an image of the prey to the evaluation apparatus 100.

Herein, a “prey” is a living body or an object that is preyed upon by a predator. The “prey” is provided to the predator as feed or food. The “prey” may be, for example, algae or other plants, or an animal. The “predator” is a living body that sustains its life or grows by preying upon a prey. The “predator” may be an animal that preys upon a prey.

In the present embodiment, the “prey” may be microscopic underwater organism, and a prey group including a plurality of (alternatively, numerous) such “prey” in water or in liquid is provided as a sample. As an example, the “prey” may be chlorella or nannochloropsis, and the “predator” may be rotifer.

In the present embodiment, the image capturing apparatus 20 is a flow imaging apparatus. The flow imaging apparatus causes a liquid sample to flow in a narrow flow channel, thereby causing the plurality of prey included in the sample to pass through a flow channel one by one. The flow imaging apparatus then performs image-capturing of each individual prey that flows through the flow channel one by one, thereby capturing an image (such as an image for each cell of the prey) of each individual prey included in the sample. In this manner, the image capturing apparatus 20 can capture an image of each of thousands to ten thousands of individuals, for example. Note that, the image capturing apparatus 20 may capture an image of each individual including an image of an object that is not the prey (such as a living body that is not preyed upon by the predator).

In another embodiment, the image capturing apparatus 20 may be a microscope apparatus that captures a field of view in which the sample is enlarged. In this case, the image capturing apparatus 20 may output a captured image including an image of each individual of the prey.

The evaluation apparatus 100 is connected to the image capturing apparatus 20. The evaluation apparatus 100 may be a computer such as a personal computer (PC), a tablet computer, a smartphone, a workstation, a server computer, or a general purpose computer, or may be a computer system in which a plurality of computers are connected. Such a computer system is also a computer in a broad sense. In addition, the evaluation apparatus 100 may also be implemented by one or more virtual computer environments that can be executed in the computer. Alternatively, the evaluation apparatus 100 may be a dedicated computer designed for evaluation of the prey, or may be dedicated hardware achieved through a dedicated circuit.

The evaluation apparatus 100 has an image acquisition unit 110, an image storage unit 120, a feature quantity extracting unit 130, an erasing unit 140, and a prediction unit 150. The image acquisition unit 110 is communicatively connected to the image capturing apparatus 20, and acquires an image of the prey captured by the image capturing apparatus 20 by using wired communication or wireless communication. The image acquisition unit 110 according to the present embodiment acquires, from the image capturing apparatus 20 which is the flow imaging apparatus, an image of each prey included in the sample.

The image acquisition unit 110 may acquire images of all prey included in the sample, or may acquire images of some of the prey included in the sample. With the evaluation apparatus 100, the accuracy of the learning model can be further improved by further increasing the number of prey to be sampled, even when images of some of the prey included in the sample are acquired.

The image storage unit 120 is connected to the image acquisition unit 110 and a learning data storage unit 170. The image storage unit 120 receives, from the image acquisition unit 110 or the learning data storage unit 170, and stores therein the image of the prey to be subjected to feature quantity extracting processing and prediction processing by the feature quantity extracting unit 130 and the prediction unit 150.

The feature quantity extracting unit 130 is connected to the image storage unit 120. The feature quantity extracting unit 130 extracts a feature quantity of the prey from the image of the prey stored in the image storage unit 120. The feature quantity extracting unit 130 may include an extraction model 135 to which the image of the prey is input and which extracts and outputs the feature quantity of the prey by using the image of the prey input. In the present embodiment, a case in which the feature quantity extracting unit 130 includes the extraction model 135 generated through learning is exemplified. Alternatively, the feature quantity extracting unit 130 may not include the extraction model 135 generated through learning and may extract the feature quantity of the prey from the image of the prey by using a predetermined calculation formula or algorithm.

The erasing unit 140 is connected to the feature quantity extracting unit 130. The erasing unit 140 erases or deletes the image of the prey from the image storage unit 120 in response to the feature quantity of the prey being extracted from the image of the prey stored in the image storage unit 120.

The prediction unit 150 is connected to the feature quantity extracting unit 130. The prediction unit 150 predicts the feature quantity of the predator that preys upon the prey based on the feature quantity of each prey extracted by the feature quantity extracting unit 130. The prediction unit 150 may include a prediction model 155 to which a feature quantity of a plurality of prey is input, and which predicts, based on the input feature quantity of a plurality of prey, the feature quantity of the predator having been fed with these plurality of prey.

The evaluation apparatus 100 may have a label acquisition unit 160, a learning data storage unit 170, and a learning processing unit 180 in order to generate the extraction model 135 and the prediction model 155 through learning. The label acquisition unit 160 acquires, as a label for learning on the sample, the feature quantity of the predator that can be observed from the predator as a result of the predator being fed with the sample to grow. The label acquisition unit 160 may be an input apparatus, and may receive operation by an observer or the like of the predator to acquire the feature quantity of the predator. Alternatively, the label acquisition unit 160 may acquire an image of the predator from the flow imaging apparatus or a microscope apparatus to extract the feature quantity of the predator that is to be noted.

The learning data storage unit 170 is connected to the image acquisition unit 110 and the label acquisition unit 160. For each of the one or more samples, the learning data storage unit 170 stores the image of each prey included in the sample acquired by the image acquisition unit 110 and the label of the sample acquired by the label acquisition unit 160. For each of the one or more samples, the learning data storage unit 170 may store learning data (also indicated as “learning data set”) including a set of the feature quantity of the one or more prey included in the sample and the feature quantity of the predator that preys upon these prey.

The learning processing unit 180 is connected to the feature quantity extracting unit 130, the prediction unit 150, and the learning data storage unit 170. The learning processing unit 180 performs learning processing in which the prediction model 155 is generated or updated through learning by using the learning data stored in the learning data storage unit 170. The learning processing unit 180 may perform learning processing in which the extraction model 135 is generated or updated through learning by using the learning data stored in the learning data storage unit 170.

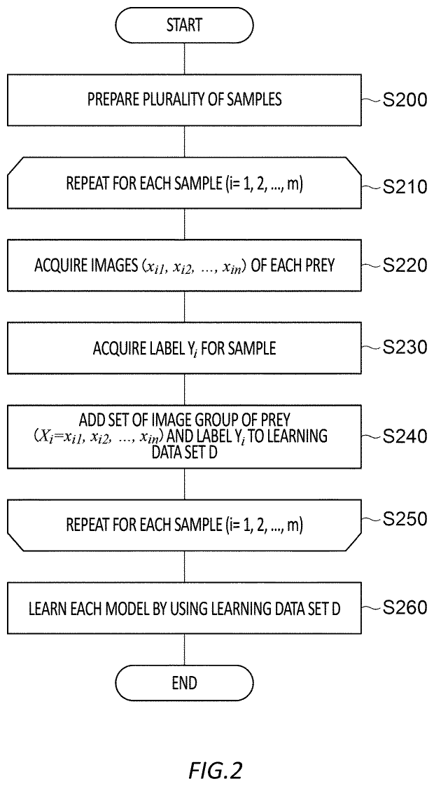

FIG. 2 illustrates a learning processing flow of the evaluation system 10 according to the present embodiment. At step 200 (S200), a plurality of samples are prepared. The combination of prey included the sample and the ratio of each prey may be different for each sample. Each sample is a prey group including a plurality of prey.

At S210 to S250, the processing of S220 to S240 is repeated for each sample among the plurality of samples. In the example of the present figure, the processing of S220 to S240 is performed for each sample i (l=1, 2, . . . , m) in m samples.

At S220, the image capturing apparatus 20 captures images xᵢ₁, xᵢ₂, . . . , xᵢₙ of each prey included in the sample i. Herein, n is the quantity of prey included in the sample i. Note that, the quantity n of the prey included in the sample may be different for each sample. The image acquisition unit 110 acquires the images xᵢ₁, xᵢ₂, . . . , xᵢₙ of each prey from the image capturing apparatus 20.

At S230, the label acquisition unit 160 acquires a label Yᵢ for the sample i. Herein, as the label Yᵢ for the sample i, the feature quantity that can be observed from the predator (predator group) as a result of feeding the predator (predator group) with the sample i to grow may be assigned.

Note that, the sample i to be captured by the image capturing apparatus 20 and the sample i to be fed to the predator may be exactly the same. That is, the sample I may be fed to the predator after being subjected to image-capturing processing by the image capturing apparatus 20. Alternatively, the sample i prepared at S220 may be partially subjected to image-capturing by the image capturing apparatus 20, and at least a part of the rest may be fed to the predator. By sufficiently stirring the sample i, the composition of the sample i subjected to image-capturing by the image capturing apparatus 20 can be considered to be substantially the same as the composition of the sample i fed to the predator.

In addition, the predator group to be fed with each of the plurality of samples may be the same or different individuals. When fed and grown with the same sample, the plurality of predator groups that are of the same type tend to indicate the feature quantity according to that sample. Therefore, when the quantity of the samples used for the learning processing and the quantity of the predator group to be fed with the samples are sufficient, the learning processing unit 180 can generate the extraction model 135 and the prediction model 155 to enable prediction of the feature quantity according to the sample without depending on differences among predator groups.

At S240, the image acquisition unit 110 and the label acquisition unit 160 store, in the learning data storage unit 170, sets of images xᵢ₁, xᵢ₂, . . . , xᵢₙ of each prey included in the sample i and the label Yᵢ of the sample i. In this manner, the image acquisition unit 110 and the label acquisition unit 160 add the learning data for the sample i to the learning data set D in the learning data storage unit 170. The evaluation apparatus 100 repeats the processing of S220 to S240 for each sample i.

At S260, the learning processing unit 180 performs learning processing to learn the prediction model 155 by using the learning data set D stored in the learning data storage unit 170. The learning processing unit 180 may perform the learning processing of learning the extraction model 135 by using the learning data set D stored in the learning data storage unit 170. The learning processing unit 180 may update the learning target model by performing further learning by using a new learning data set D on the already learned prediction model 155 or extraction model 135.

The learning processing unit 180 may generate the prediction model 155 by learning the feature quantity of the predator that is available as an evaluation value of the prey in the prey group by using learning data including sets of the feature quantity of each prey in the prey group including one or more prey and the feature quantity of the predator that preys upon the prey in the prey group. When the sample is a prey group formed of a plurality of prey, a label indicating the feature quantity of the predator can be applied to the prey group, instead of the individual prey. The learning processing unit 180 may train the extraction model 135 and the prediction model 155 to output a predicted value of the feature quantity of the predator fed with the prey group upon input of an image of each prey in the prey group, for the entire model including the extraction model 135 and the prediction model 155 by performing multiple instance learning, for example.

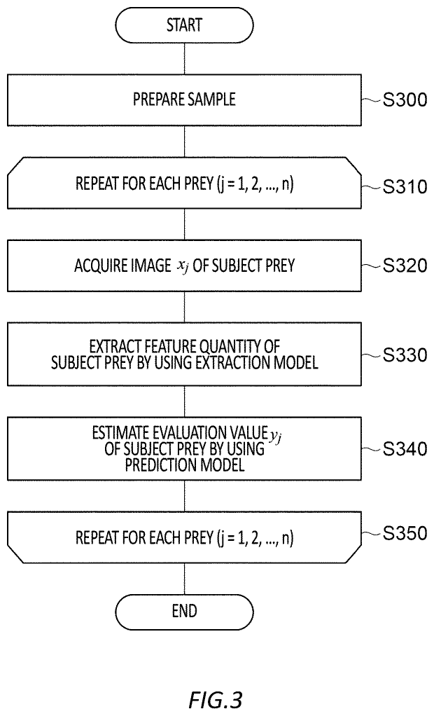

FIG. 3 illustrates an evaluation processing flow of the evaluation system 10 according to the present embodiment. At S300, the sample to be evaluated is prepared. The sample is a prey group including one or more prey to be evaluated.

At S310 to S350, the evaluation apparatus 100 repeats the processing of S320 to S340 for each prey in the sample. In the example of the present figure, the evaluation apparatus 100 performs processing from S320 to S340 for each prey j (j=1, 2, . . . , n) of n prey in the sample. Herein, n is the quantity of prey included in the sample. Note that, the quantity n of the prey included in the sample may be different according to the sample. In addition, the evaluation apparatus 100 may perform processing of S320 to S340 for only a part of the prey in the sample.

At S320, the image capturing apparatus 20 captures an image xⱼ of the subject prey j to be evaluated. The image acquisition unit 110 acquires the image xⱼ of the subject prey j from the image capturing apparatus 20 and stores it in the image storage unit 120.

At S330, the feature quantity extracting unit 130 reads the image xⱼ of the subject prey j from the image storage unit 120 and inputs it to the extraction model 135. The extraction model 135 extracts the feature quantity of the subject prey j from the input image xⱼ of the subject prey j.

At S340, the prediction unit 150 inputs the feature quantity of the subject prey j to the prediction model 155 received from the feature quantity extracting unit 130, and estimates the evaluation value yⱼ of the subject prey j by using the prediction model 155. The prediction unit 150 may receive the feature quantity of only one subject prey j to be evaluated, and input it to the prediction model 155. The prediction unit 150 may estimate an evaluation value yⱼ of the subject prey j by using prediction of the feature quantity of the predator obtained in response to the feature quantity of only one subject prey j being input to the prediction model 155. The evaluation apparatus 100 repeats the processing of S320 to S340 for each prey j.

According to the evaluation apparatus 100 described above, an evaluation value of the prey to be evaluated can be estimated based on a result of inputting the feature quantity of the prey to be evaluated to the prediction unit 150 having been subjected to learning to predict the feature quantity of the predator that preys upon the prey based on the feature quantity of each prey included in the sample. Note that, the evaluation apparatus 100 may be supplied with a captured image related to the subject prey j to be estimated for the evaluation value, instead of acquiring the image of each prey j from the image capturing apparatus 20.

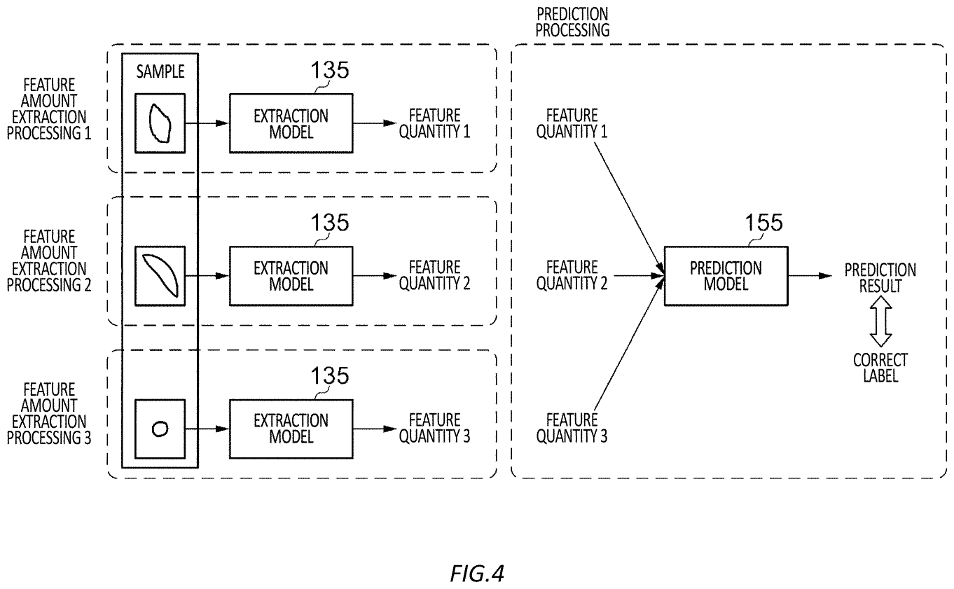

FIG. 4 is a schematic view of a learning processing of the evaluation system 10 according to the present embodiment. The evaluation system 10 trains the extraction model 135 and the prediction model 155 by selecting, randomly or in order among a plurality of sets of the sample i and the label Yᵢ included in the learning data, a learning target set, predicting the feature quantity of the predator from the images xᵢ₁, xᵢ₂, . . . , xᵢₙ of each prey included in the sample i of the selected set, and updating a parameter of the extraction model 135 and the prediction model 155 to reduce an error between the predicted feature quantity of the predator and the label Yᵢ, which is the correct answer.

Herein, the processing of predicting the feature quantity of the predator from images xᵢ₁, xᵢ₂, . . . , xᵢₙ of each prey included in the sample i of the learning target set is processing that is similar to normal prediction processing to predict the feature quantity of the predator obtained as a result of feeding and growing the predator with a sample. Thus, the such prediction processing will be first described by using the present figure.

The prediction processing of predicting the feature quantity of the predator from an image of each prey can be divided into feature quantity extracting processing to extract the feature quantity of the prey from an image of the prey for each prey and prediction processing to predict the feature quantity of the predator from the feature quantity of each prey.

In the feature quantity extracting processing, the feature quantity extracting unit 130 inputs the images xᵢ₁, xᵢ₂, . . . , xᵢₙ of each prey and extracts the feature quantity of each prey. The feature quantity extracting unit 130 may extract the feature quantity of the prey from the image of the prey by using a predetermined transformation equation or algorithm or the like. The feature quantity extracting unit 130 may extract a known index value that can be measured from the image, such as a size, an area, a shape, a color, or the like of the prey in the image, for example.

The feature quantity extracting unit 130 may input the images xᵢ₁, xᵢ₂, . . . , xᵢₙ of each prey to the extraction model 135 generated through the learning, and use a value output by the extraction model 135 as the feature quantity of each prey. The extraction model 135 may be a neural network such as a CNN (Convolutional Neural Network), a SVM (Support Vector Machine), or other machine learning models, as an example. Such a machine learning model can adjust internal parameters to bring the output data output according to the input data for learning closer to a target value, and thereby enable learning to output desired output data according to the input data.

The feature quantity of the prey output by the feature quantity extracting unit 130 may be a scalar value or a vector value (that is, a feature vector)

The feature quantity extracting unit 130 may output, as the feature quantity of the prey, a feature vector including either one or both of the one or two or more feature values extracted by a predetermined algorithm or the like from the image and one or two or more feature values extracted by using the extraction model 135 generated through learning from the image.

The feature quantity extracting unit 130 may sequentially extract the feature quantity by successively processing the images xᵢ₁, xᵢ₂, . . . , xᵢₙ of the plurality of prey. For example, the feature quantity extracting unit 130 may extract the feature quantity of the prey 1 from the image xᵢ₁, then extract the feature quantity of the prey 2 from the image xᵢ₂, then extract the feature quantity of the prey 3 from the image xᵢ₃, and extract the feature quantity of each prey thereafter in order in a similar manner. More specifically, the image storage unit 120 sequentially reads from the learning data storage unit 170 and stores an image of each of the plurality of prey included in the prey group, which is a sample to be processed, and the feature quantity extracting unit 130 sequentially extracts the feature quantity of the prey from the image of each of the plurality of prey stored in the image storage unit 120. In this case, the erasing unit 140 may sequentially delete, from the image storage unit 120, the image of prey for which the feature quantity extracting processing has completed. In addition, the feature quantity extracting unit 130 may release a storage area used for the feature quantity extracting processing of one prey before starting the feature quantity extracting processing for the next prey. In this manner, the evaluation apparatus 100 can reduce the storage capacity of the image storage unit 120 and the storage capacity used by the feature quantity extracting unit 130 can be reduced while retaining the feature quantity that has been calculated for the prey.

Note that, the feature quantity extracting processing for the plurality of prey can be performed independently from each other. Therefore, the feature quantity extracting unit 130 may perform the feature quantity extracting processing for two or more prey among the plurality of prey through parallel processing or concurrent processing. In this case, the image storage unit 120 and the feature quantity extracting unit 130 secure storage capacity to be used for the feature quantity extracting processing to be performed in parallel or concurrently.

In the prediction processing to predict the feature quantity of the predator from the image of each prey, the prediction unit 150 predicts the feature quantity of the predator fed with the prey group based on the feature quantity of each of the plurality of prey included in the prey group. The prediction unit 150 may input the feature quantity of the plurality of prey to the prediction model 155, and predict the feature quantity of the predator fed with these plurality of prey by using the prediction model 155.

The prediction unit 150 may have a prediction model 155, which is a neural network, a SVM, or another machine learning model. The learning processing unit 180 may generate or update the prediction model 155 by using multiple instance learning. The prediction model 155 may include a pooling function or a pooling layer to aggregate the feature quantity of the plurality of prey, in order to input and process each feature quantity of the plurality of prey, which may differ in number depending on the sample. As an example, the prediction model 155 may have, as such a pooling function or a pooling layer, a function or a layer for calculating or selecting one or more of a largest value, a smallest value, an average value, or another representative value among the feature quantity of the plurality of prey (alternatively, a corresponding feature value). The prediction model 155 may aggregate the feature quantities of the plurality of prey by weighting them based on attention (such as taking a weighted sum), and use it as the feature quantity of the sample.

Next, the learning processing of the prediction model 155 will be described. The learning processing unit 180 calculates, as the error between the predicted value and the actual value, a difference between the feature quantity of the predator predicted based on the feature quantity of each prey included in the learning target sample i and the label Yᵢ associated with the sample i. The learning processing unit 180 adjusts the parameter in the prediction model 155 that can be adjusted through learning so as to reduce this error. For example, when a neural network is used as the prediction model 155, the learning processing unit 180 adjusts the weight among each neuron and a bias of each neuron in the neural network and through an approach such as back propagation by using the error between the label and the output value output by the neural network in response to the feature quantity of each prey included in the learning target sample i in the learning data being input. Note that, the learning processing unit 180 may perform learning to reduce the error between the predicted value and the correct answer through a learning method according to an algorithm of machine learning adopted by the prediction model 155.

When a learnable extraction model 135 is used, the learning processing unit 180 may adjust an adjustable parameter through learning in the extraction model 135 to reduce the error between the predicted feature quantity of the predator and the label. For example, when a neural network is used as the prediction model 155, the learning processing unit 180 propagates the error from the output layer to the input layer by using back propagation in the learning of the prediction model 155. In this manner, the learning processing unit 180 can calculate an input error of the prediction model 155. When the neural network is used as the extraction model 135, the learning processing unit 180 can feedback the input error of the prediction model 155 as an output error of the extraction model 135, and further adjust an adjustable parameter through learning of the extraction model 135 by using an approach such as back propagation.

Note that, when multiple instance learning is used, the prediction model 155 has a pooling function or a pooling layer. According to the processing content of the pooling function or the pooling layer, the learning processing unit 180 may select the feature quantity extracting processing, among the plurality of feature quantity extracting processing, the result of which being fedback with the output error. When the prediction model 155 includes a pooling function or a pooling layer that selects the largest or smallest feature quantity, among the feature quantities of the plurality of prey, for example, the learning processing unit 180 may feedback an output error for the feature quantity extracting processing of the prey of which the feature quantity was the largest among the plurality of prey to update the extraction model 135. When the prediction model 155 includes a pooling function or a pooling layer that outputs an average feature quantity of the feature quantities of the plurality of prey, for example, the learning processing unit 180 may feedback an output error for the feature quantity extracting processing of all of the plurality of prey or the feature quantity extracting processing of one or two or more prey selected randomly among the plurality of prey to update the extraction model 135. When the prediction model 155 includes a pooling function or a pooling layer that aggregates the feature quantities of the plurality of prey by weighting them based on attention, for example, the learning processing unit 180 may feedback an output error with larger weight for the feature quantity extracting processing of the prey with larger attention among the plurality of prey to update the extraction model 135.

In the learning processing described above, the feature quantity extracting unit 130 may store, in the learning data storage unit 170 in association with the sample i, the feature quantity of each prey extracted from images xᵢ₁, xᵢ₂, . . . , xᵢₙ of each prey included in the learning target sample i. In this manner, the learning processing unit 180 can skip the processing of extracting the feature quantity of the prey from the image by reading from the learning data storage unit 170 and using the feature quantity of each prey in the learning processing of the prediction model 155. Therefore, the learning processing unit 180 can perform the learning processing of the prediction model 155 independently from the feature quantity extracting processing by the feature quantity extracting unit 130.

In addition, in a configuration in which learning of the extraction model 135 is not required, in response to the feature quantity of the prey being stored in the learning data storage unit 170 in association with the learning target sample i, the erasing unit 140 may erase the image of that prey from the learning data storage unit 170. In this manner, the evaluation apparatus 100 is no longer required store numerous images for each of the plurality of samples in the learning data storage unit 170, allowing the storage capacity of the learning data storage unit 170 to be significantly reduced.

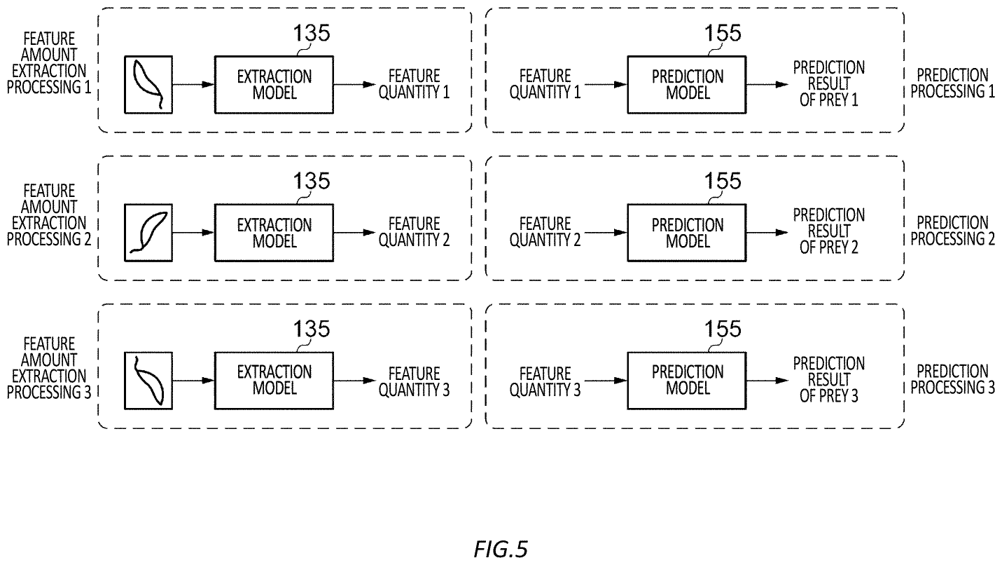

FIG. 5 is a schematic view of evaluation processing of the evaluation system 10 according to the present embodiment. With the learning processing unit 180 according to the present embodiment, in the learning processing shown in FIG. 4, the learning processing unit 180 performs learning processing of the extraction model 135 and the prediction model 155 to make the feature quantity of the predator predictable based on the image of each prey in the prey group, which is to be the sample. In the example of the present embodiment, the feature quantity of the predator to be predicted may be the feature quantity that is available as the evaluation value of the prey in the prey group.

That is, in the present example, a prey group to be a suitable feed for growing the predator is evaluated more highly, and a prey group that is not preferable as a feed for growing the predator is evaluated more lowly. In this manner, the evaluation system 10 according to the present embodiment can evaluate the prey group or prey from the perspective of whether it is suitable for growing the predator.

For a feature quantity of such a predator, one or more index values indicating whether the predator is growing well may be selected in advance. Such an index value may be a value indicating, for example, a size, area, shape, number, or the like of the predator or alternatively, a combination of these values, although it may differ depending on the type of the predator. In addition, the feature quantity of the predator may be a feature quantity having, as a target value or an actual value, an evaluation value such as a scoring result of the growth state input by an observer of the predator for each sample.

In the present embodiment, the evaluation apparatus 100 utilizes the extraction model 135 and the prediction model 155 having been subjected to learning to predict the feature quantity of the predator that is available as the evaluation value of the prey in the prey group by using a feature quantity of each prey in the prey group to be the sample, to enable estimation of the evaluation value of individual prey. In order to achieve this, the evaluation apparatus 100 predicts the feature quantity of the predator with respect to the prey group virtually including only one prey by inputting the feature quantity of only one prey and not inputting the feature quantity of other prey to the prediction model 155. The feature quantity of the predator predicted in this manner will be one obtained by predicting the feature quantity of the predator fed with only one prey, which will become available as the evaluation value of the one prey.

In the evaluation processing illustrated in the present figure, the image acquisition unit 110 acquires the image of each of the plurality of prey included in the prey group of the sample used for the evaluation, and stores them in the image storage unit 120 (also refer to S310 in FIG. 3). The feature quantity extracting unit 130 extracts the feature quantity of each prey from the image of each of the plurality of prey stored in the image storage unit 120 (also refer to S330 in FIG. 3).

Herein, the erasing unit 140 may erase, from the image storage unit 120, at least one image, among the image of each of the plurality of prey stored in the image storage unit 120, from which the feature quantity of the prey has already been extracted, before prediction of the feature quantity of the predator by the prediction unit 150. In the example of the present figure, when the image storage unit 120 sequentially receives and stores an image of the prey 1, an image of the prey 2, an image of the prey 3, . . . , and the feature quantity extracting unit 130 the sequentially extracts the feature quantity of the prey 1, the feature quantity of the prey 2, the feature quantity of the prey 3, . . . from the image of the prey 1, the image of the prey 2, the image of the prey 3, . . . , the erasing unit 140 may erase the image of the prey 1 from the image storage unit 120 in response to the feature quantity of the prey 1 being extracted. In this manner, the erasing unit 140 can suppress the number of images retained in the image storage unit 120, and can reduce the storage capacity used as the image storage unit 120.

The prediction unit 150 inputs the feature quantity of one prey, and predicts the feature quantity of the predator based on the input feature quantity of the one prey (also refer to S340 in FIG. 3). The evaluation apparatus 100 may output the predicted feature quantity of the predator as the evaluation value of the targeted one prey.

Herein, depending on the type of the pooling function or the pooling layer of the prediction model 155, the prediction result may vary according to the number of feature quantities input to the prediction model 155. For example, since the growth state of the predator may vary depending on the number of prey included in the sample per unit volume, calculation such as total sum of the feature quantities of the prey may be included in the pooling function or the pooling layer. In this case, the prediction unit 150 may have a predetermined number of feature quantities of the same prey input to the prediction model 155. In this manner, the prediction unit 150 can predict the feature quantity of the predator when the same prey is fed by an amount of prey that is standardly included in the sample per unit volume, for example.

Note that, instead of capturing an image of the prey to be evaluated from the sample, the evaluation apparatus 100 may calculate an evaluation value of the prey to be evaluated by using an image selected from the images of the prey that have already been acquired and stored in the learning data storage unit 170 or the like. The evaluation apparatus 100 may receive the image of the prey to be evaluated from a network, an external file system or the like, and calculate the evaluation value of the prey to be evaluated.

The evaluation system 10 described above can present, to the user, the type (kind, strain, state or the like) of the prey that can be used as a feed to grow the predator better, by predicting and outputting the evaluation value of the individual prey included in the sample. Therefore, the evaluation system 10 can be utilized for analysis of natural phenomenon that causes the predator to grow. In addition, the user presented with the evaluation value of the prey by the evaluation system 10 can adjust the type of the prey to be included in the feed to promote growth of the predator.

In order to automate adjustment of the feed to be given to the predator, the evaluation apparatus 100 may further comprise a feed manufacturing apparatus that selects the prey to be fed to the predator from a plurality of types of prey or adjusts the formulation of each type of prey in the feed to be fed to the predator. The feed manufacturing apparatus may manufacture a feed with higher formulation of a prey with a higher evaluation value and lower formulation of a prey with a lower evaluation value by using an evaluation value of each prey output by the prediction unit 150.

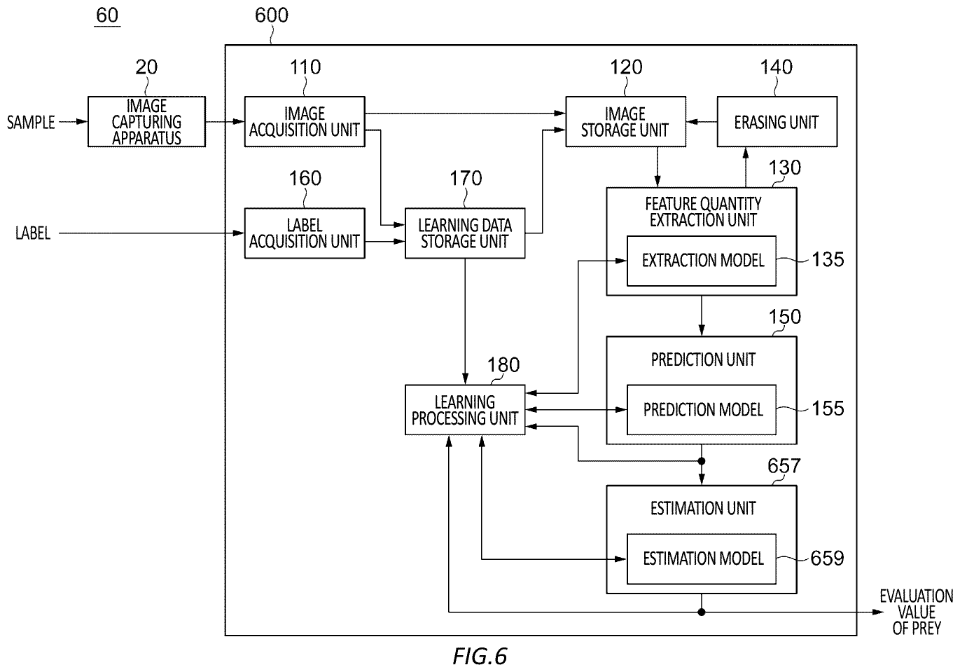

FIG. 6 illustrates a configuration of an evaluation system 60 according to a modified example of the present embodiment. The evaluation system 60 according to the present modified example is a modified example of the evaluation system 10 illustrated in FIGS. 1 to 5, so description thereof is omitted below except for the differences therewith. The evaluation system 60 comprises an image capturing apparatus 20 and an evaluation apparatus 600.

The evaluation apparatus 600 is a modified example of the evaluation apparatus 100. Instead of using, as the evaluation value of the prey, the feature quantity of the predator output by the prediction unit 150 in response to the feature quantity of the prey being input, the evaluation apparatus 600 estimates the evaluation value of the prey by using the feature quantity of the predator output by the prediction unit 150. The evaluation apparatus 600 further has an estimation unit 657 in addition to each component of the evaluation apparatus 100 illustrated in FIGS. 1 to 5.

The estimation unit 657 is connected to the prediction unit 150 and the learning processing unit 180. The estimation unit 657 estimates the evaluation value of the prey by using the prediction of the feature quantity of the predator by the prediction unit 150. The estimation unit 657 is responsible for converting, into an evaluation value of the prey, the feature quantity of the predator output in response to the prediction unit 150 inputting the feature quantity of one prey. The estimation unit 657 may convert, into an evaluation value of the prey, the feature quantity of the predator such as the size, area, shape, color, quantity, or the like of the predator by using a predetermined transformation equation or algorithm.

The estimation unit 657 may include an estimation model 659. The estimation model 659 inputs the feature quantity of the predator, and estimates the evaluation value of the prey fed to the predator based on the input feature quantity of the predator. The estimation model 659 may be a neural network, a SVM, or another machine learning model, as an example.

In the present modified example, the label acquisition unit 160 of the evaluation apparatus 600 acquires a label Zᵢ indicating a correct answer of the evaluation value of the prey, in addition to the label Yᵢ indicating a correct answer of the feature quantity of the predator for the sample i at S230 in FIG. 2. The label acquisition unit 160 may be operated by an observer or the like of the predator to acquire the evaluation value of the prey.

At S240 in FIG. 2, the image acquisition unit 110 and the label acquisition unit 160 of the evaluation apparatus 600 store, in the learning data storage unit 170, sets of images xᵢ₁, xᵢ₂, . . . , xᵢₙ of each prey included the sample i and the labels Yᵢ and Zᵢ of the sample i. At S260 in FIG. 2, the learning processing unit 180 of the evaluation apparatus 600 performs learning processing in which the estimation model 659 is subjected to learning, by using a learning data set D stored in the learning data storage unit 170.

For the learning target sample I included in the learning data set D, the learning

processing unit 180 adjusts the adjustable parameter through learning in the estimation model 659 so as to reduce or minimize an error between the label Zᵢ and the output data output by the estimation model 659 in response to the label Yᵢ indicating the feature quantity of the predator being input to the estimation model 659 as the input data for learning. For example, when a neural network is used as the prediction model 155, the learning processing unit 180 adjusts the weight among each neuron and a bias of each neuron in the neural network and through an approach such as back propagation by using the error between the label and the output value output by the neural network in response to the feature quantity of each prey included in the learning target sample i in the learning data being input. Note that, the learning processing unit 180 may perform the learning processing to subject the extraction model 135 and the prediction model 155 to learning in a similar manner to that illustrated in FIG. 2 and FIG. 4 by using the learning data set D.

At S340 in the evaluation processing of FIG. 3, the estimation unit 657 receives a predicted value of the feature quantity of the predator output by the prediction unit 150, and inputs it to the estimation model 659. The estimation unit 657 may output an evaluation value zⱼ of a subject prey j estimated by the estimation model 659 based on the predicted value of the feature quantity of the predator obtained in response to the feature quantity of only one subject prey j being input to the prediction model 155.

According to the evaluation apparatus 600 described above, by having the estimation unit 657 that estimates the evaluation value of the prey from the feature quantity of the predator, the evaluation value of the prey can be estimated from the feature quantity of the predator predicted by using the image or feature quantity of the prey.

Various embodiments of the present invention may be described with reference to flowcharts and block diagrams whose blocks may represent (1) steps of processes in which operations are performed or (2) sections of apparatuses responsible for performing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations specified in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer-readable instructions may be provided for a processor or programmable circuit of a general purpose computer, special purpose computer, or other programmable data processing apparatuses such as a computer locally or via a wide area network (WAN) such as a local area network (LAN), the Internet, or the like, and execute the computer readable instructions in order to create means for executing the operations specified in flowcharts or block diagrams. Examples of the processor include a computer processor, a processing unit, a microprocessor, a digital signal processor, a controller, a microcontroller, and the like.

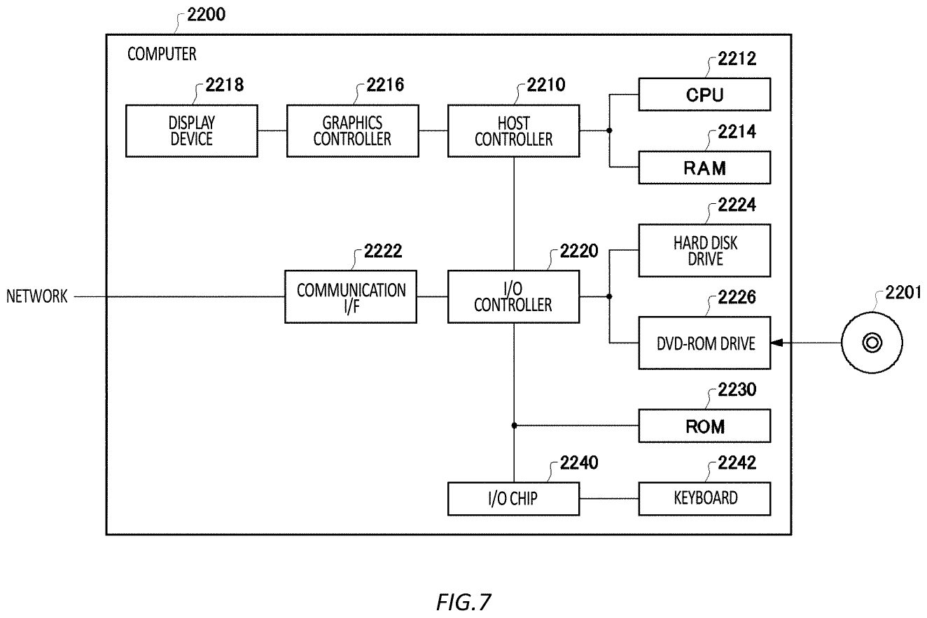

FIG. 7 illustrates an example of a computer 2200 in which a plurality of aspects of the present invention may be entirely or partially embodied. A program installed in the computer 2200 can cause the computer 2200 to function as an operation associated with the apparatuses according to the embodiments of the present invention or as one or more sections of the apparatuses, or can cause the operation or the one or more sections to be executed, and/or can cause the computer 2200 to execute a process according to the embodiments of the present invention or a step of the process. Such programs may be executed by a CPU 2212 to cause the computer 2200 to perform specific operations associated with some or all of the blocks in the flowcharts and block diagrams described in the present specification.

The computer 2200 according to the present embodiment includes the CPU 2212, a RAM 2214, a graphics controller 2216, and a display device 2218, which are interconnected by a host controller 2210. The computer 2200 also includes input/output units such as a communication interface 2222, a hard disk drive 2224, a DVD-ROM drive 2226, and an IC card drive, which are connected to the host controller 2210 via an input/output controller 2220. The computer also includes legacy input/output units such as an ROM 2230 and a keyboard 2242, which are connected to the input/output controller 2220 via an input/output chip 2240.

The CPU 2212 operates according to programs stored in the ROM 2230 and the RAM 2214, thereby controlling each unit. The graphics controller 2216 acquires image data generated by the CPU 2212 in a frame buffer or the like provided in the RAM 2214 or in itself, such that the image data is displayed on the display device 2218.

The communication interface 2222 communicates with other electronic devices via a network. The hard disk drive 2224 stores programs and data used by the CPU 2212 in the computer 2200. The DVD-ROM drive 2226 reads a program or data from a DVD-ROM 2201 and provides the program or data to the hard disk drive 2224 via the RAM 2214. The IC card drive reads the programs and the data from the IC card, and/or writes the programs and the data to the IC card.

The ROM 2230 stores therein boot programs and the like executed by the computer 2200 at the time of activation, and/or programs that depend on the hardware of the computer 2200. The input/output chip 2240 may also connect various input/output units to the input/output controller 2220 via a parallel port, a serial port, a keyboard port, a mouse port, or the like.

Programs are provided by a computer-readable medium such as the DVD-ROM 2201 or the IC card. The programs are read from the computer-readable medium, are installed in the hard disk drive 2224, the RAM 2214, or the ROM 2230 which is also an example of the computer-readable medium, and are executed by the CPU 2212. The information processing described in these programs is read by the computer 2200, and provides cooperation between the programs and the various types of hardware resources. The apparatus or method may be configured by implementing operations or processing of information according to use of the computer 2200.

For example, in a case where communication is performed between the computer 2200 and an external device, the CPU 2212 may execute a communication program loaded in the RAM 2214 and instruct the communication interface 2222 to perform communication processing based on processing described in the communication program. Under the control of the CPU 2212, the communication interface 2222 reads transmission data stored in a transmission buffer processing region provided in a recording medium such as the RAM 2214, the hard disk drive 2224, the DVD-ROM 2201, or the IC card, transmits the read transmission data to the network, or writes reception data received from the network in a reception buffer processing region or the like provided on the recording medium.

In addition, the CPU 2212 may cause the RAM 2214 to read all or a necessary part of a file or database stored in an external recording medium such as the hard disk drive 2224, the DVD-ROM drive 2226 (DVD-ROM 2201), the IC card, or the like, and may execute various types of processing on data on the RAM 2214. Then, the CPU 2212 writes the processed data back in the external recording medium.

Various types of information such as various types of programs, data, tables, and databases may be stored in a recording medium and subjected to information processing. The CPU 2212 may execute, on the data read from the RAM 2214, various types of processing including various types of operations, information processing, conditional judgement, conditional branching, unconditional branching, information retrieval/replacement, or the like described throughout the present disclosure and specified by instruction sequences of the programs, and writes the results back to the RAM 2214. In addition, the CPU 2212 may retrieve information in a file, a database, or the like in the recording medium. For example, when a plurality of entries, each having an attribute value of a first attribute associated with an attribute value of a second attribute, is stored in the recording medium, the CPU 2212 may retrieve, out of the plurality of entries, an entry with the attribute value of the first attribute specified that meets a condition, read the attribute value of the second attribute stored in said entry, and thereby acquiring the attribute value of the second attribute associated with the first attribute meeting a predetermined condition.

The programs or software modules described above may be stored in a computer-readable medium on or near the computer 2200. In addition, a recording medium such as a hard disk or a RAM provided in a server system connected to a dedicated communication network or the Internet can be used as a computer-readable medium, thereby providing a program to the computer 2200 via the network.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

It should be noted that each process of the operations, procedures, steps, stages, and the like performed by the apparatus, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: evaluation system,
60: evaluation system,
20: image capturing apparatus,
100: evaluation apparatus,
110: image acquisition unit,
120: image storage unit,
130: feature quantity extracting unit,
135: extraction model,
140: erasing unit,
150: prediction unit,
155: prediction model,
160: label acquisition unit,
170: learning data storage unit,
180: learning processing unit,
600: evaluation apparatus,
657: estimation unit,
659: estimation model,
2200: computer,
2201: DVD-ROM,
2210: host controller,
2212: CPU,
2214: RAM,
2216: graphics controller,
2218: display device,
2220: input/output controller,
2222: communication interface,
2224: hard disk drive,
2226: DVD-ROM drive,
2230: ROM,
2240: input/output chip,
2242: keyboard.

What is claimed is:

1. An evaluation apparatus comprising:
a prediction unit that predicts, based on a feature quantity of a prey, a feature quantity of a predator that preys upon the prey,
wherein an evaluation value of the prey is estimated based on a result obtained by inputting the feature quantity of the prey to the prediction unit.

2. The evaluation apparatus according to claim 1, wherein the prediction unit has a prediction model having learned, by using learning data including a set of the feature quantity of the prey and the feature quantity of the predator that preyed upon the prey, the feature quantity of the predator that is available as an evaluation value of the prey.

3. The evaluation apparatus according to claim 1 comprising an estimation unit that estimates an evaluation value of the prey by using prediction of the feature quantity of the predator by the prediction unit.

4. The evaluation apparatus according to claim 1 comprising:
an image acquisition unit that acquires an image of the prey; and
a feature quantity extracting unit that extracts the feature quantity of the prey from the image of the prey.

5. The evaluation apparatus according to claim 4, wherein
the prediction unit predicts, based on a feature quantity of each of a plurality of prey included in a prey group, the feature quantity of the predator having been fed with the prey group.

6. The evaluation apparatus according to claim 5, wherein
the image acquisition unit acquires an image of each of the plurality of prey included in the prey group and stores the image in an image storage unit, and
the feature quantity extracting unit extracts the feature quantity of the prey from the image of each of the plurality of prey stored in the image storage unit,
the evaluation apparatus further comprising an erasing unit that erases, from the image storage unit, at least one image, among images of the plurality of prey, from which the feature quantity of the prey has already been extracted, before prediction of the feature quantity of the predator by the prediction unit.

7. The evaluation apparatus according to claim 5, wherein by using prediction of the feature quantity of the predator obtained in response to a feature quantity of only one subject prey to be evaluated being input to the prediction unit, an evaluation value of the subject prey is estimated.

8. The evaluation apparatus according to claim 1, wherein the prey is chlorella or nannochloropsis, and the predator is rotifer.

9. An evaluation method comprising:
predicting, by a prediction unit, based on a feature quantity of a prey, a feature quantity of a predator that preys upon the prey; and
estimating an evaluation value of the prey based on a result obtained by inputting the feature quantity of the prey to the prediction unit.

10. The evaluation method according to claim 9, wherein the prediction unit has a prediction model having learned, by using learning data including a set of the feature quantity of the prey and the feature quantity of the predator that preyed upon the prey, the feature quantity of the predator that is available as an evaluation value of the prey.

11. The evaluation method according to claim 9 wherein in the estimating the evaluation value of the prey, an evaluation value of the prey is estimated by using prediction of the feature quantity of the predator by the prediction unit.

12. The evaluation method according to claim 9 comprising:
acquiring an image of the prey; and
extracting the feature quantity of the prey from the image of the prey.

13. The evaluation method according to claim 12, wherein
the prediction unit predicts, based on a feature quantity of each of a plurality of prey included in a prey group, the feature quantity of the predator having been fed with the prey group.

14. The evaluation method according to claim 9 wherein the prey is chlorella or nannochloropsis, and the predator is rotifer.

15. A non-transitory computer readable medium having recorded thereon an evaluation program that is executed by a computer to:
cause the computer to function as a prediction unit that predicts, based on a feature quantity of a prey, a feature quantity of a predator that preys upon the prey; and
cause the computer to estimate an evaluation value of the prey based on a result obtained by inputting the feature quantity of the prey to the prediction unit.

16. The non-transitory computer readable medium according to claim 15, wherein the prediction unit has a prediction model having learned, by using learning data including a set of the feature quantity of the prey and the feature quantity of the predator that preyed upon the prey, the feature quantity of the predator that is available as an evaluation value of the prey.

17. The non-transitory computer readable medium according to claim 15, wherein the evaluation program further causes the computer to function as an estimation unit that estimates an evaluation value of the prey by using prediction of the feature quantity of the predator by the prediction unit.

18. The non-transitory computer readable medium according to claim 15, wherein the evaluation program further causes the computer to function as:
an image acquisition unit that acquires an image of the prey; and
a feature quantity extracting unit that extracts the feature quantity of the prey from the image of the prey.

19. The non-transitory computer readable medium according to claim 18, wherein the prediction unit predicts, based on a feature quantity of each of a plurality of prey included in a prey group, the feature quantity of the predator having been fed with the prey group.

20. The non-transitory computer readable medium according to claim 15, wherein the prey is chlorella or nannochloropsis, and the predator is rotifer.
